(19) United States
(12) Patent Application Publication
(10) Pub. No.: US 2007/0193767 A1
(43) Pub. Date: Aug. 23, 2007

(54) Electricity transport conductor for overhead lines

(76) Inventors: Daniel Guery, Dour (BE); Michel Martin, Thuin (BE); Philippe Dubois, Braives (BE); Michel Alexandre, Ougree (BE); Fabrice Dubouloz, Le Bourget du Lac (FR); Leila Bonnaud, Maubeuge (FR); Guy Guerlement, Nouvelles (BE); Jacques Lobry, Mons (BE)

Correspondence Address: SOFER & HAROUN LLP., 317 MADISON AVENUE, SUITE 910, NEW YORK, NY, 10017, US

(21) Appl. No.: 11/698,795

(22) Filed: Jan. 26, 2007

(30) Foreign Application Priority Data
Feb. 1, 2006 (FR) 06 50354

(51) Int. Cl. H01B 9/02

(52) U.S. Cl. 174/106 R

(57) ABSTRACT

The invention relates to a method of fabricating an electricity transport conductor, in particular for overhead power lines, that are to operate at an operating temperature greater than or equal to 200° C., and comprising at least one composite central core 1 made of continuous fibers impregnated with an epoxy resin matrix, the core being covered in at least one layer of insulating material 2, and conductor wires 3 of aluminum or aluminum alloy being wound around the core. According to the invention, said insulating material is compatible with said operating temperature and is put into place on said core 1 without subsequent heating.

### RELATED APPLICATION

This application is related to and claims the benefit of priority from French Patent Application No. 06 50354, filed on Feb. 1, 2006, the entirety of which is incorporated herein by reference.

### FIELD OF THE INVENTION

The invention relates to an electricity transport conductor for high voltage overhead lines.

The invention relates more particularly to a conductor comprising at least one composite central core made up of continuous fibers and impregnated by a matrix of thermosetting resin, and conductor wires of aluminum or aluminum alloy disposed around the core.

### BACKGROUND OF THE INVENTION

Such a conductor is described in patent document JP 03-129606.

In that prior art document, the composite core is constituted by organic or inorganic fibers, e.g. aramid, silicon carbide, or carbon fibers, impregnated by a synthetic resin, preferably an epoxy resin. That core may be coated in a polyimide resin or it may be taped in a polyimide film, forming an insulating layer. Conductor wires of aluminum are wound around such a core or a set of such cores in order to form an electricity transport conductor.

The function of the polyimide covering is to avoid problems of corrosion at the interface between the conductor wires and the core including carbon fibers.

Regardless of whether the polyimide covering is made by coating or by taping, it is necessary to pass the covered core through a drying oven after the covering has been put into place.

With conductors for overhead lines, there are three types of temperature to be taken into consideration:
the maximum temperature acceptable under steady conditions;
the maximum temperature acceptable during overloads of short, medium, or long duration; and
the maximum temperature acceptable during a short circuit.

It can be desired to make overhead line conductors that are designed in such a manner that the maximum acceptable temperature in all three of the above circumstances is greater than or equal to 200° C., which temperature is referred to below as the operating temperature.

In order to form a continuous insulating sheath of polyimide around the core, it is necessary to heat said taped or coated polyimide layer to a temperature greater than 300° C. Under such conditions, the insulating layer as formed in that way is compatible with a conductor having its operating temperature greater than or equal to 200° C.

Unfortunately, applying heat treatment at such a temperature greater than 300° C. degrades the epoxy resin of the core, which begins to deteriorate at a temperature of about 250° C.

It can therefore be seen that fabrication in that way does not enable an electric cable to be obtained having an operating temperature that can be as high as 200° C. or more.

### OBJECTS AND SUMMARY OF THE INVENTION

The invention solves this problem and provides a method of fabricating an electricity transport conductor, in particular for overhead power lines, having an operating temperature greater than or equal to 200° C. and including at least one composite central core made of continuous fibers impregnated by a matrix of epoxy resin, the core being covered in at least one layer of insulating material, and conductor wires of aluminum or aluminum alloy being wound around the core, wherein said insulating material is compatible with said operating temperature and is put into place on said core without subsequent heating.

In a first preferred implementation, said insulating material is extruded onto said core.

Preferably, said insulating material is a poly-ether-ether-ketone.

Advantageously, said insulating material is poly (oxy-1,4-phenylene-oxy-1,4-phenylene-carbonyl-1,4-phenylene).

In a second preferred implementation, said insulating material is constituted by at least one tape placed on said core.

Preferably, the nature of the insulating material is glass fiber.

The invention also provides an electricity transport conductor made by such a method, said conductor wires are wound to form at least one layer covering said core, itself covered in said insulating material.

Preferably, the conductor includes a plurality of composite cores, at least one of which is covered in a said layer of insulating material.

It may also comprise a plurality of composite cores contained in a common said layer of insulating material.

Said conductor wires may be wires of round shape, of trapezoidal shape, or of Z shape.

Said fibers are preferably made of carbon.

### BRIEF DESCRIPTION OF THE DRAWINGS

The invention is described below in greater detail with reference to figures that merely show preferred implementations of the invention.

FIGS. 1 to 6 are cross-section views of electricity transport conductors in accordance with the invention.

### MORE DETAILED DESCRIPTION

These figures show an electricity transport conductor, in particular for overhead power lines presenting an operating temperature that is greater than or equal to 200° C. The conductor comprises at least one composite central core 1 made up of fibers, preferably continuous filaments of carbon fibers, impregnated by a matrix of thermosetting resin, preferably epoxy resin, the core being covered in a layer of insulating material 2, and by conductor wires of aluminum or aluminum alloy 3 that are wound around the core.

By using a pultrusion method, the continuous fibers are impregnated with resin, and then the resulting core is subjected to heat treatment with its temperature being raised continuously.

Such a core providing mechanical reinforcement has the advantages of presenting specific weight that is low, and of accepting mechanical stresses that are high.

The core constituted by a plurality of continuous carbon fiber filaments that are assembled together and impregnated with epoxy resin is such that:
its breaking stress is greater than or equal to 2.6 gigapascals (GPa);
its breaking elongation is greater than 2%;
its modulus of elasticity is greater than 90 GPa;
its coefficient of linear expansion is less than 2×10⁻⁶/° C.;
its specific weight is less than 2 kilograms per cubic decimeter (kg/dm³);
its carbon fiber content by weight is greater than 70%;
after aging for 30 days at the operating temperature of 200° C., its breaking stress is greater than or equal to 2.6 GPa, and this applies under both of the following circumstances: core under a mechanical load of 25% of its initial breaking stress, and core under no mechanical load; and
after being wound through 180° on a maximum diameter of 120 times the diameter of the core and then subjected on three consecutive occasions to a mechanical load equal to 25% of its initial breaking stress, the core presents breaking stress greater than or equal to 2.6 GPa.

The number of composite cores used for a conductor is such that it passes an alternating bending test for demonstrating that the stresses present during stringing, i.e. while passing under mechanical tension through pulleys does not affect or degrade the performance of the conductor.

The conductor is tensioned to 15% of its nominal breaking load. A carriage is installed on the conductor, the carriage comprising three pulleys placed in a vertical plane and having their axes placed in a common horizontal plane. The spacing between the extreme pulleys is 3200 millimeters (mm)±600 mm.

The pulleys are of the same type as those used when stringing conventional conductors on overhead lines (the groove bottoms are lined with neoprene):

| Diameter of bottom of pulley groove | Diameter of conductor |
|---|---|
| (mm) | (mm) |
| 800 | =38 |
| 1000 | >38 |

The carriage performs go-and-return movements at a horizontal speed lying in the range 0.5 meters per second (m/s) to 2 m/s over a distance lying in the range 50 meters (m) to 60 m. The acceleration and breaking are carried out without jolting.

The assembly comprising the conductor and the accessories must withstand at least 95% of the nominal breaking load of the conductor.

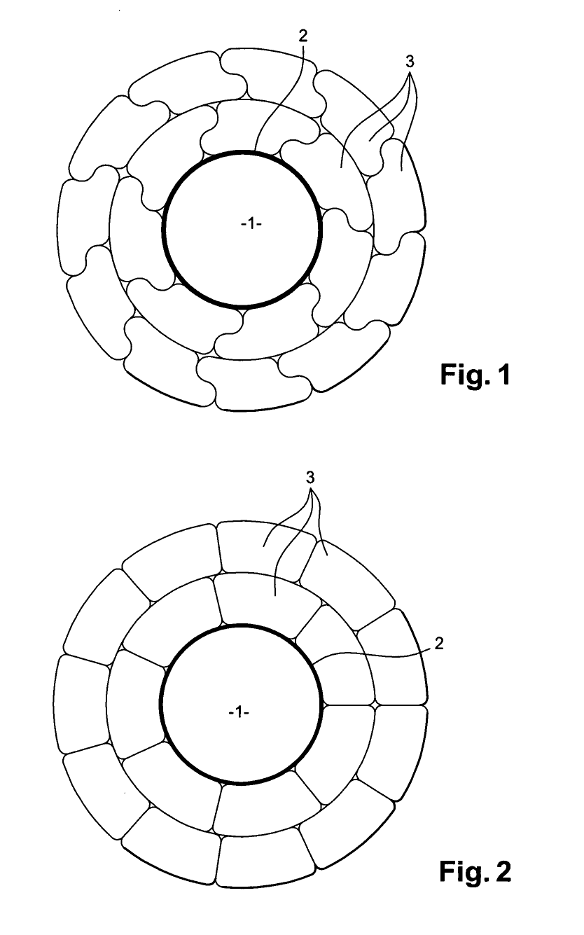

In FIG. 1, a single core 1 is located centrally and is covered in a layer of insulating material 2. Conductor wires 3 of aluminum or aluminum alloy, in this case wires of Z shape, are wound on the core in two layers.

In FIG. 2, a single core 1 is located centrally and is covered in a layer of insulating material 2. Conductor wires 3 of aluminum or aluminum alloy, in this case wires of trapezoid shape, are wound on the core in two layers.

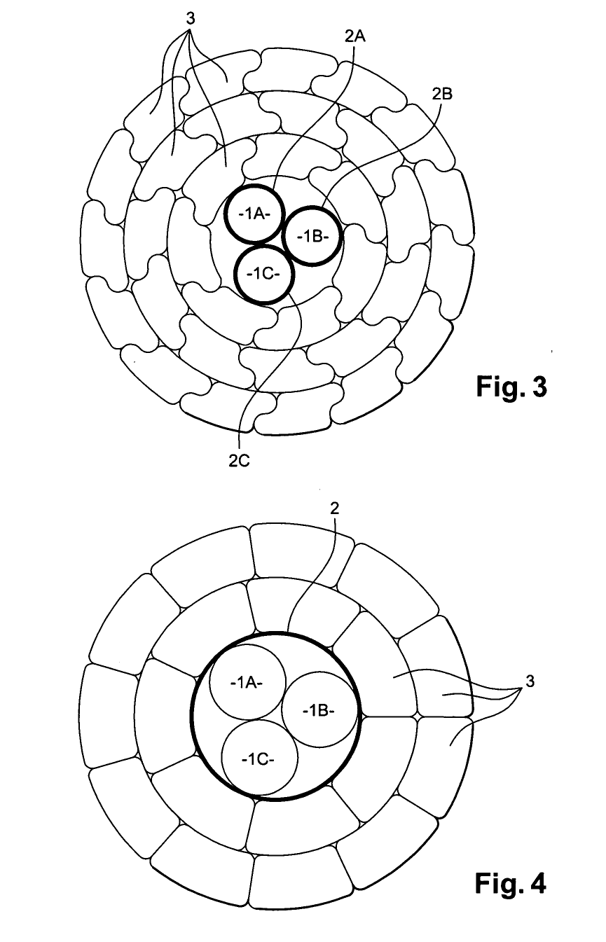

In FIG. 3, three cores 1A, 1B, and 1C are disposed centrally, each core being covered in a layer of insulating material 2A, 2B, 2C. Conductor wires 3 of aluminum or aluminum alloy, in this case of Z shape, are wound on these cores in three layers.

In FIG. 4, three cores 1A, 1B, and 1C are disposed centrally and are covered in a single layer of insulating material 2. Conductor wires 3 of aluminum or aluminum alloy, in this case wires of trapezoid shape, are wound on these cores in two layers.

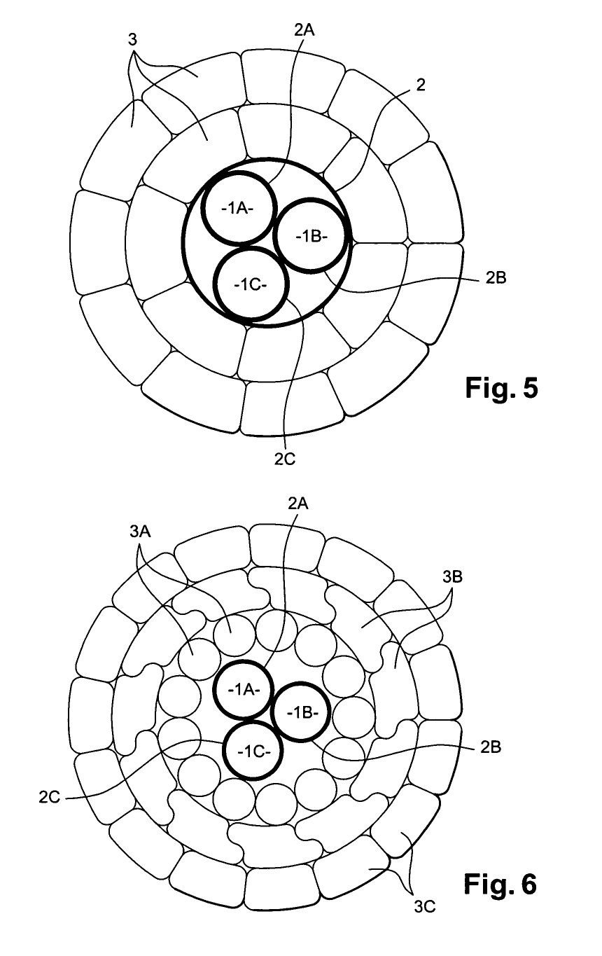

In FIG. 5, three cores 1A, 1B, and 1C are disposed centrally and are covered firstly in respective layers of insulating material 2A, 2B, 2C, and secondly in a common layer of insulating material 2. Conductor wires 3 of aluminum or aluminum alloy, in this case of trapezoid shape, are wound on these cores in two layers.

In FIG. 6, three cores 1A, 1B, and 1C are disposed centrally, each being covered in a respective layer of insulating material 2A, 2B, 2C. Conductor wires 3 of aluminum or aluminum alloy are wound on these cores in three layers, a first layer being made up of round wires 3A, a second layer of Z-shaped wires 3B, and a third layer of trapezoid-shaped wires 3C.

According to the invention, the insulating material of the layers 2 is compatible with the operating temperature being greater than or equal to 200° C. and is put into place on the core 1 without subsequent heating.

In a first implementation, the insulating material is extruded onto the core 1 and is constituted by a poly-ether-ether-ketone.

Preferably, use is made of poly (oxy-1,4-phenylene-oxy-1,4-phenylene-carbonyl-1,4-phenylene), as sold under the name Victrex PEEK.

In a second implementation, the insulating material is constituted by at least one tape of glass fibers.

What is claimed is:

1. A method of fabricating an electricity transport conductor, in particular for overhead power lines, having an operating temperature greater than or equal to 200° C. and including at least one composite central core made of continuous fibers impregnated by a matrix of epoxy resin, the core being covered in at least one layer of insulating material, and conductor wires of aluminum or aluminum alloy being wound around the core, wherein said insulating material is compatible with said operating temperature and is put into place on said core without subsequent heating.

2. A method according to claim 1, wherein said insulating material is extruded onto said core.

3. A method according to claim 2, wherein said insulating material is a poly-ether-ether-ketone.

4. A method according to claim 3, wherein said insulating material is poly (oxy-1,4-phenylene-oxy-1,4-phenylene-carbonyl-1,4-phenylene).

5. A method according to claim 1, wherein said insulating material is constituted by at least one tape placed on said core.

6. A method according to claim 5, wherein the nature of the insulating material is glass fiber.

7. A conductor made by the method according to claim 1, wherein said conductor wires are wound to form at least one layer covering said core, itself covered in said insulating material.

8. A conductor according to claim 7, including a plurality of composite cores, at least one of which is covered in a said layer of insulating material.

9. A conductor according to claim 7, including a plurality of composite cores contained in a common said layer of insulating material.

10. A conductor according to claim 7, wherein said conductor wires are wires of round shape, of trapezoid shape, or of Z shape.

11. A conductor according to claim 7, wherein said fibers are of carbon.
